(19) United States
(12) Patent Application Publication
(10) Pub. No.: US 2006/0085239 A1
(43) Pub. Date: Apr. 20, 2006

(54) Method of selecting and matching professionals

(76) Inventor: Tracey R. Thomas, Boonton, NJ (US)

Correspondence Address: Alozie N. Etufugh, Esq.;Law Offices of Alozie N. Etufugh, PLLC, Suite 4D, 30 Central Park South, New York, NY, 10019, US

(21) Appl. No.: 11/250,843

(22) Filed: Oct. 14, 2005

Related U.S. Application Data
(60) Provisional application No. 60/618,957, filed on Oct. 14, 2004.

(51) Int. Cl. G06F 9/44

(52) U.S. Cl. 705/7

(57) ABSTRACT

A method of selecting desired professionals in a system by a user which includes the process of forming a collective of repair persons on a system and allows users to sign on to the system. Once signed on to the system, users are able to search for matching repair persons based on search criteria provided by the users. With a match, the repair persons and users are notified and they proceed to schedule the project.

### CROSS REFERENCE TO RELATED APPLICATIONS

This application is a non-provisional application conversion for provisional application Ser. No. 60/618,957 filed Oct. 14, 2004 by Tracey R. Thomas.

### TECHNICAL FIELD OF THE INVENTION

The present invention relates generally to the selection and matching professionals in a field. More specifically, the selection and matching of professionals in order to meet certain customer demands or criteria.

### BACKGROUND OF THE INVENTION

Real estate investors and homeowners alike have difficulty finding reliable home repair persons. While lists of home repair individuals and companies are available on various websites, these lists or websites fail to be useful to real estate investors or homeowners as there is no objective rating system for the listed repair persons/companies. In addition, there is no easy way to determine whether the listed repair persons'/companies' pricing presents a competitive or desired value. Furthermore, none of these sites provides information pertaining to bonding (insurance), experience, or any other criteria deemed relevant by real estate investors or homeowners. An investor or homeowner seeking to undertake a repair project would like to find or be matched with the right repair person for the right price while meeting some other criteria as defined by the investor or homeowner.

As such, there is a need for a comprehensive and interactive system that allows for the efficient matching of homeowners with repair persons by virtue of certain criteria such as experience, bonding, ratings, reviews, cost, etc.

### SUMMARY OF THE INVENTION

Accordingly, it is an advantage of the present invention to provide a method of matching real estate investors or homeowners with the repair person(s) of their choice by virtue of certain criteria defined by the real estate investor or homeowner.

Another advantage of the present invention is that repair persons are rewarded for the quantity, quality of service and other factors as rated by the system in accordance with the invention.

An additional advantage of the present invention is that the site owner or administrator negotiates a group or individual discounts for repair persons that offer services on the site.

An additional advantage of the present invention is that users are rewarded (in a rewards system) for the frequency of their use of the system service and other factors as rated by the system in accordance with the invention.

An additional advantage of the present invention is where the rewards system is an automated cash rebate system, discount system, or points-based system where the points can be used like cash to purchase awards, get discounts on services or parts and materials on the system site or at other merchant locations and websites.

An additional advantage of the present invention is that real estate investors or homeowners can be referred to another site or service should there be no match in the system.

An additional advantage of the present invention is the ability for real estate investors, homeowners and repair persons to signup for the service in one integrated database thereby allowing for tracking, discounts eligibility, recording etc.

A further advantage of the present invention is that repair persons are encouraged to provide quality service in a timely fashion by virtue of an awards system.

An even further advantage of the present invention is the implementation of a method for matching real estate investors or homeowners with the repair person(s) of their choice by way of integrated internet-based systems, local database systems, and phone-in systems or the like etc.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a flow chart showing the process undertaken by a customer (e.g. a real estate investor or a homeowner) signing on to the system in accordance with the invention.

FIG. 2 is a flow chart showing the process undertaken by an interested customer with a check for membership and opportunity to sign up as a member of the system in accordance with the invention.

FIG. 3 is a flow chart showing the matching process and options for the customer should there be no match.

FIG. 4 is a flow chart showing the process undertaken by a customer in accordance with the invention where the customer is provided with recommendations if no match is made.

FIGS. 5-8 are flow charts showing repair persons' interaction with the system in accordance with the invention.

FIG. 9 is a flow chart showing the implementation of an awards program in accordance with the invention.

### DESCRIPTION OF THE PREFERRED EMBODIMENT (S)

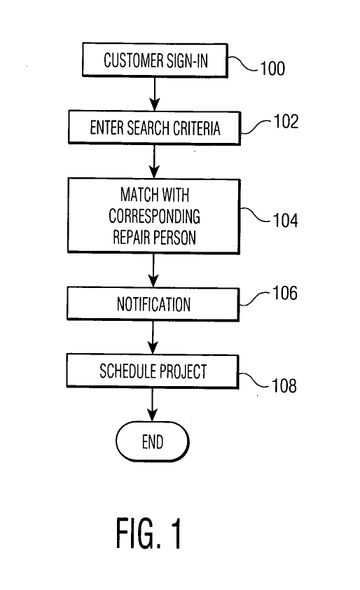

FIG. 1 shows a customer's interaction with the system in accordance with the invention. In step 100, the customer signs on to the system. Such signing on may include providing a phone number, password, fingerprint reading or the like, etc. In a preferred embodiment, the signing on process would be free and would not require detailed background information on the customer's part. After the customer has signed on, he or she is then required to enter certain search criteria in step 102. Search criteria may be anything that pertains to the work the customer needs to be done, the repair person's insurance levels, insurance coverage regarding the repairs and other information regarding insurance coverage, repair person's bonding levels, repair person's level of experience, repair person's rating, etc., where the rating can be provided by the site or based on user ratings. Next, the system matches the criteria provided by the customer with repair person information (step 104). In an alternate embodiment, the customer is provided with a list of repair persons or providers meeting the criteria that are ranked based on search factors. In a further alternative embodiment, after the match is made, the customer may be able to obtain additional information on the repair person such as results of a background check, credit check etc. This service may be provided for a premium fee. Following the match, both the customer and the repair person matched is notified of the match (step 106). This notification could be done in a number of ways including, voice or text messaging, electronic mail, instantaneous on-screen notification, etc. After the repair person has been notified, the customer then schedules the project with the repair person (step 108). Alternatively, the system owner or administrator could coordinate scheduling by obtaining the availability of the customer and the repair person(s) and confirming the appointment. The customers are later queried by the site after the project is complete to provide feedback and ratings on the site, the repair person(s) and the scheduled project. Still further, the repair persons may be rewarded by the site based on the number of times they have provided service to site users or on the feedback and ratings they receive from customers. The site owner may also reward and rate the repair person based on availability, promptness in scheduling and other factors. The site owner or administrator may also negotiate group or individual discounts for repair persons that offer services on the site. These discounts may be passed on to end users, where the repair persons show the end users via a quote or upon final billing to show how much they saved because of the discount or where the site owner or administrator communicates the same savings via email, telephone or the mail. Additionally, users may be rewarded for the number of times and frequency of their use of the system service and other factors such as referring the site to other users, referring additional repair persons to the site, and participating in events or promotions sponsored by the site. Further still, the rewards system may be a manual or automated cash rebate system, discount system, or points-based system where the points can be used like cash to purchase awards, get discounts on services or parts and materials on the system site or at any merchant locations and websites. Rewards and available awards to repair persons or users can also be provided by service partners (like Home Depot or Lowes) based on purchases made at the service partner. It is also contemplated that the system and methods of the present invention allow for an integrated approach regarding access to the repair person and services (services herein should also be construed to include goods) offered by the site. For example, users may access the same or similar information regarding repair persons and services online on the site, over the telephone, via a local database that may be supplied via download to the user or some other storage medium, or on site at a location owned or operated by the site administrator or owner.

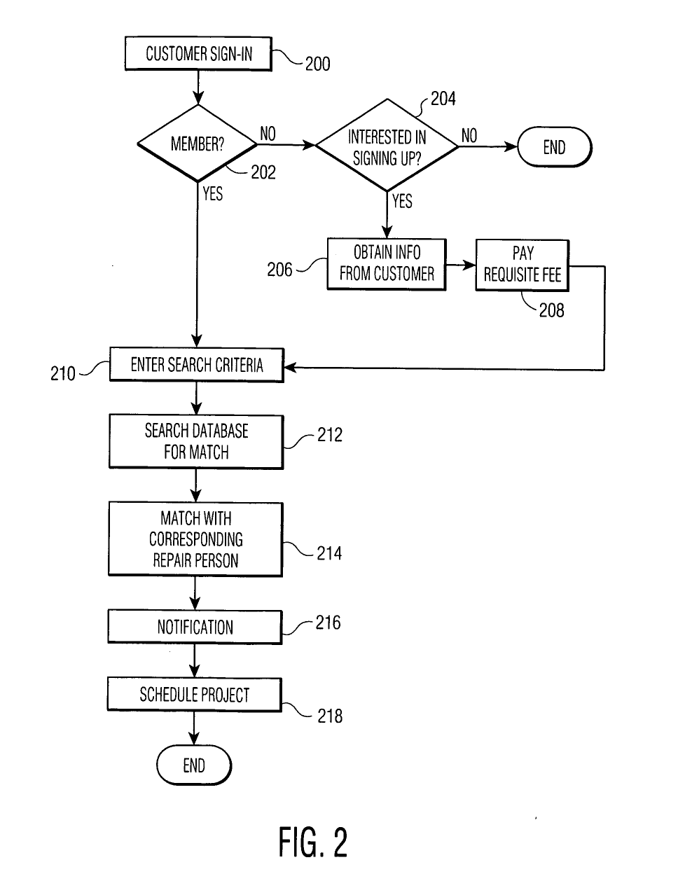

FIG. 2 shows a flow chart in accordance with the invention. After the customer signs in (step 200), the customer is queried about his or her membership status (step 202). If the customer is a current member, he/she is granted access to the system (step 210) and proceeds to the subsequent steps shown. If the customer is not a current member of the service, the system proceeds with step 204 where the customer is asked if he/she is interested in the service. If the customer is not interested the process ends. If, however, the customer wants to sign up, the system obtains his or her information in step 206 and requests the payment of the requisite fee from the customer (step 208). Next, the system allows the customer to search the database based on certain criteria (step 210) and a search is conducted (step 212). Once a match has been made with a repair person (step 214), both customer and repair person are notified of the match (step 216) and the customer schedules the project (step 218). Alternatively, the system owner or administrator could coordinate scheduling by obtaining the availability of the customer and repair persons and confirming the appointment. In a further alternative embodiment, after the match is made, the customer may be able to obtain additional information on the repair person such as results of a background check, credit check, or any other information the customer deems pertinent.

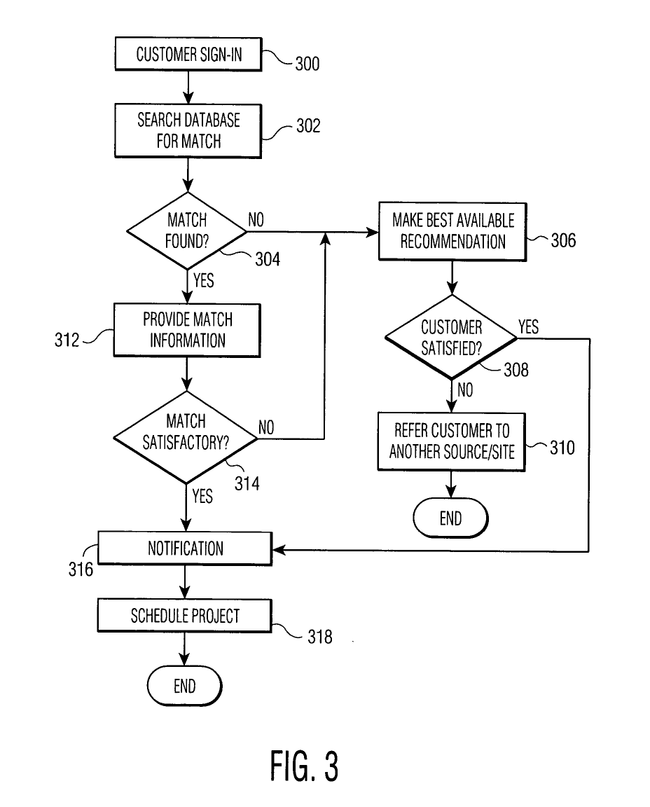

FIG. 3 shows another flow chart in accordance with the invention. After the customer signs on (step 300), he/she then searches the system by providing certain search criteria (step 302). These criteria may include services desired, cost, experience level, bonding levels etc. Once the information for the search is provided, a search of the database for an appropriate match is made and the system then determines whether a match has been made (step 304). If not, the system then makes the best available recommendation based upon the information available on the database (step 306). The customer will then have a choice to either accept the recommendation or refuse it (step 308). If he/she accepts the recommendation, the process moves on to step 316 where the repair person (best available recommendation) is notified. If he/she refuses the recommendation, the system provides another site or source for information (step 310) based on what is in the site databases, by linking to other sites or “screen-scraping” information from other sites. Referring back to step 304, if a match is made, the match information is provided (step 312). The customer then has the option of deciding whether the match is satisfactory or not (step 314). If not, the system follows the path to step 306 which path is discussed above. If the customer finds the match to be satisfactory (step 314), the matched repair person is notified (step 316) and the customer schedules the project (step 318). In an alternate embodiment, after the match is made, the customer may be able to obtain additional information on the repair person such as results of a background check, credit check, or any other information the customer deems pertinent. The customer may, depending on the results of such check(s), decline the match and proceed with the next best available recommendation (step 316).

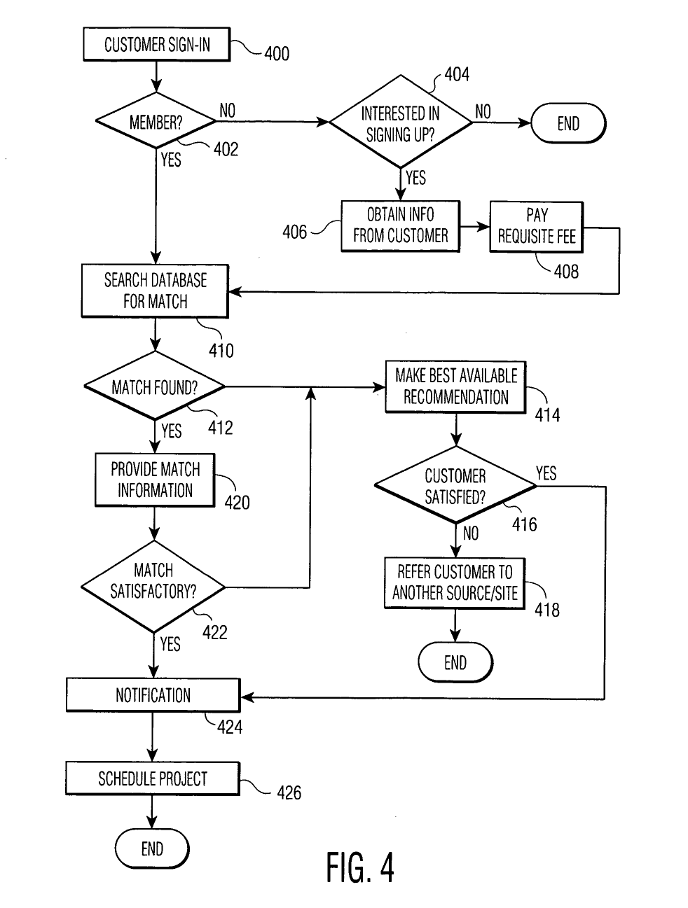

FIG. 4 shows another flow chart in accordance with the invention. After the customer signs in (step 400) he/she is queried about his/her membership status (step 402). If the customer is a current member, he/she is granted access to the system (step 410) and proceeds to the subsequent steps shown. If the customer is not a member of the service, an offer is made to sign him/her up for the service (step 404). Once the customer declines the offer, the process ends. If, however, the customer decides to sign up, the system then obtains information from the customer (step 406) and requests payment of the requisite, fee (step 408). The customer is then allowed to search the database for a match (step 410). The system then determines whether a match can be made (step 412). If a match is made, the system provides the customer with the match information (step 420) after which the customer decides whether the match is satisfactory (step 422). If the customer decides that the match is not satisfactory, the system makes the best available recommendation (step 414). If a match, following step 412 is not made, the system provides the customer with the best available recommendation from its database in step 414. Next, the customer determines whether he/she is satisfied with the best available recommendation provided (step 416). If the customer is satisfied, the process moves on to step 424 where the repair person (best available recommendation) is notified. If the customer is not satisfied, the system then refers the customer to another site, source or partner for the customer to derive information from (step 418) thereby ending the process. Referring back to step 422, if the customer is satisfied with the match, the repair person is notified and the customer then schedules the project (step 426). In an alternate embodiment, after the match is made, the customer may be able to obtain additional information on the repair person such as results of a background check, credit check, or any other information the customer deems pertinent. The customer may, depending on the results of such check(s), decline the match and proceed with the next best available recommendation (step 414).

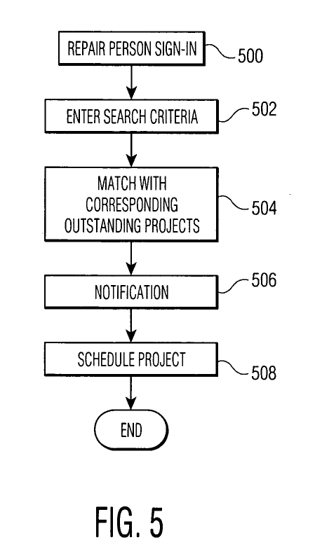

FIG. 5 is a flow chart showing a repair person's interaction with the system in accordance with the invention. The repair person signs on to the system (step 500) and enters his/her search criteria (step 502). The repair person's search criteria may be based upon a customer's budget for a given project, type of work to be done, etc. Following the repair person's input of his/her search criteria, the system matches the criteria with any available project that comports with the search criteria (step 504). The customer is then notified about the match (step 506) and the repair person schedules the project with the customer (step 508).

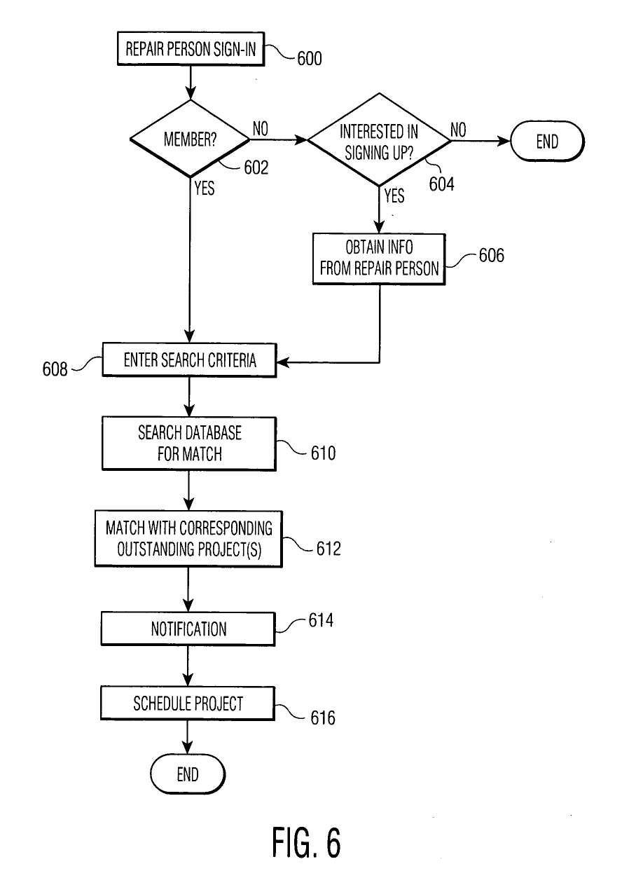

FIG. 6 shows a flow chart with another embodiment of the invention. A repair person signs on to the system (step 600) and is queried by the system about his/her membership (step 602). If the repair person is a current member, he/she is granted access to the system (step 608) and proceeds to the subsequent steps shown. If the repair person is not yet a member of the system or if his/her membership or subscription has expired, he/she is given the option to join or renew (step 604). If the repair person is interested in joining, he/she then provides information which may include his/her years of experience, bonding levels, area of expertise, industry affiliations, certifications, licenses etc. (step 606). The repair person is then granted access to the system and is allowed to search the system by entering certain search criteria (step 608). The repair person's search criteria may be based on a number of factors such as project type, time factors (scheduling availability), customers' budgets, etc. Once the repair person's criteria are entered, the system then searches for a match with customer projects meeting the repair person's criteria (step 610). If a match is made (step 612), the customer and the repair person are both notified (step 614). The repair person then schedules the project (step 616).

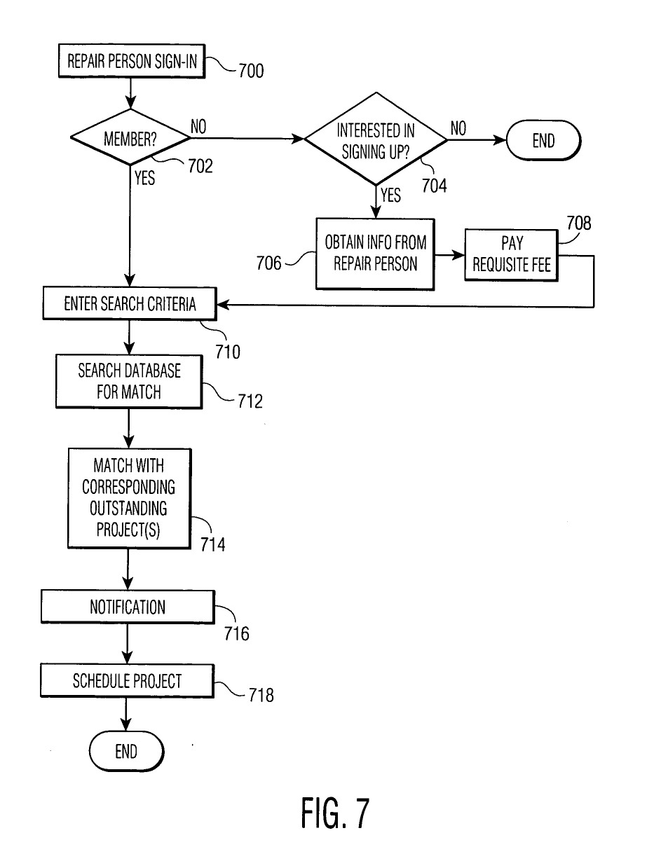

FIG. 7 shows a flow chart with another embodiment in accordance with the invention. The repair person signs on to the system (step 700) and is queried by the system about his/her membership (step 702). If the repair person is a current member, he/she is granted access to the system (step 710) and proceeds to the subsequent steps shown. If the repair person is not yet a member of the system or if his/her membership or subscription has expired, he/she is given the option to join or renew (step 704). If the repair person is interested in joining, he/she then provides information which may include his/her years of experience, bonding levels, area of expertise, industry affiliations, certifications, licenses etc. (step 706). The repair person is then required to pay a requisite fee in order to have access to the system (step 708). After the repair person has paid the fee, he/she is granted access to the system and is allowed to search the system by entering certain search criteria (step 710). The repair person's search criteria may be based on a number of factors such as project type, time factors (scheduling availability), customers' budgets, etc. Once the repair person's criteria are entered, the system then searches for a match with customer projects meeting the repair person's criteria (step 712). If a match is made (step 714), the customer and the repair person are both notified (step 716). The repair person then schedules the project (step 718).

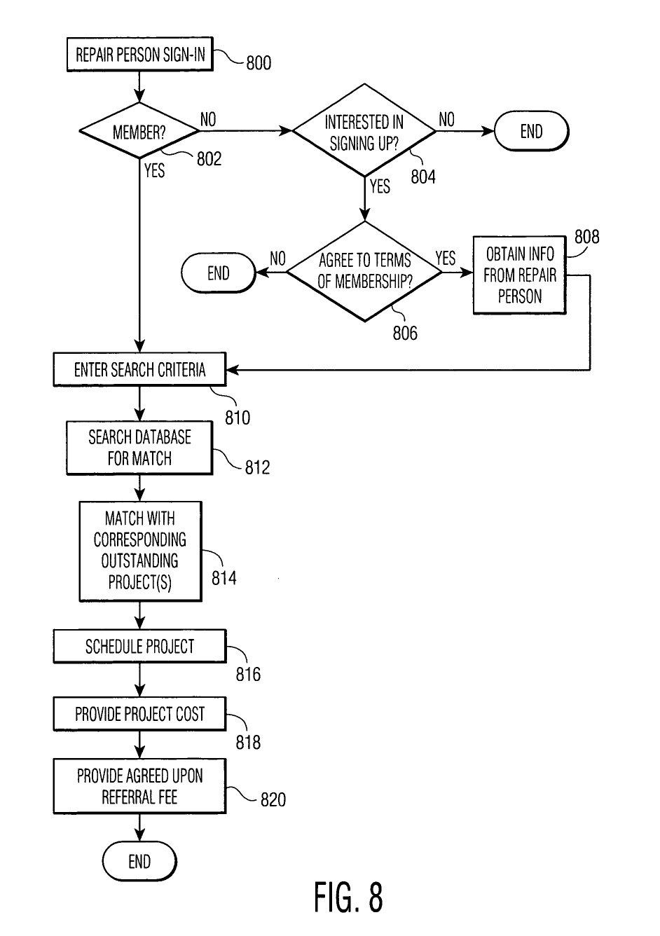

FIG. 8 shows a flow chart with another embodiment in accordance with the invention. A repair person signs on to the system (step 800) and is queried about their membership status (step 802). If the repair person is a current member, he/she is granted access to the system (step 810) and proceeds to the subsequent steps shown. If not, the system then presents him/her with the option to join or renew their membership (step 804). If the repair person is not interested, the process ends. If the repair person is interested, the system then presents the terms of membership to the repair person for approval and assent (step 806). If the repair person agrees to the terms, the system then requests and obtains information from the repair person. If the repair person does not agree to the terms of membership, the process ends. Once the system has obtained all relevant information from the repair person, the repair person is granted access to search the system for a match (steps 810 & 812). The system then searches for a match with posted projects and matches the repair person with at least one (step 814). The repair person then schedules the project (step 816). Either before or after the project has been completed, the repair person provides the overall cost for the project (step 818) and pays the agreed upon referral fee to the service (step 820).

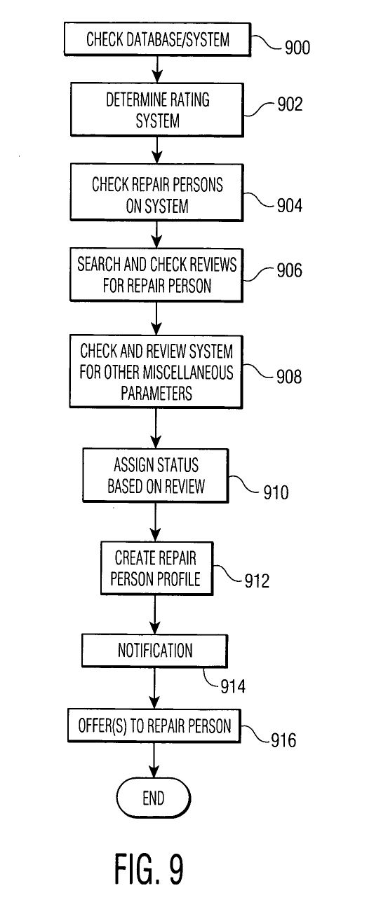

FIG. 9 shows a flow chart in accordance with the invention. The system's administrator or service partners (e.g. Home Depot)—the administrator and service partner may be the same entity in some cases—log on and check the system (step 900). The administrator then determines a rating system (step 902). Next, the administrator checks each repair person on the system by searching through reviews or other miscellaneous information on each repair person (steps 904-908). Based on the data collected and the rating system used, the administrator assigns a status to the repair person and then creates a profile based on the repair person's information and assigned status (steps 910 and 912). For example, the site may provide status levels such as “elite”, “very good”, “good”, “expensive”, “moderately priced”, “cheap” and “very cheap.” Status levels may be based on the information collected from repair persons (e.g. level of experience, records on timely delivered projects, positive or negative reviews by homeowners, etc.) and customers (reviews on repair persons, levels of satisfaction, etc.) The administrator may be a computer operated program that routinely and automatically assigns the status levels or it could be an individual authorized to conduct the tasks above. Where the administrator is a computer-operated system, the factors that determine status level are predetermined and the program assigns status levels based on the predetermined convention.

Although this invention has been disclosed with reference to specific forms and embodiments, it will be evident that a great number of variations may be made without departing from the spirit and scope of the invention. These and other changes and modifications which are obvious to those skilled in the art are intended to be included within the scope of the present invention. For example, parts or steps may be reversed, equivalent elements may be substituted for those specifically disclosed, and certain features of the invention may be used independently of other features all without departing from the invention as defined in the appended claims.

What is claimed is:

1. A method of selecting professionals in a system by a user, comprising the steps of:
a. forming a collective of repair persons;
b. signing in to the system;
c. providing search criteria;
d. matching the criteria with information on repair persons contained on the system;
e. notifying at least one person associated with the information; and
f. scheduling a project with said at least one person associated with the information.

2. A method as disclosed in claim 1 further comprising the step of providing the user with a list of repair persons meeting the user's criteria.

3. A method as disclosed in claim 1 further comprising the step of obtaining additional information on a repair person.

4. A method as disclosed in claim 1 wherein the scheduling step further comprises the steps of:
a. coordinating the schedules of the user and the repair person; and
b. confirming an appointment.

5. A method as disclosed in claim 1 further comprising the step of providing feedback.

6. A method as disclosed in claim 1 further comprising the step of rating the repair persons.

7. A method as disclosed in claim 1 further comprising the steps of:
a. determining whether a match has been made;
b. providing match information relating to said determination;
c. offering the user an alternative recommendation;
d. determining whether the customer is satisfied with the alternative recommendation; and
e. referring the customer to another source.

8. A method as disclosed in claim 1 further comprising the steps of:
a. checking the user's membership status;
b. checking the user's interest in signing up with the system; and
c. obtaining information from the user.

9. A method as disclosed in claim 8 further comprising the step of paying a requisite fee.

10. A method as disclosed in claim 8 further comprising the steps of:
a. determining whether the user agrees to a set of terms;
b. providing the cost of a project; and
c. providing an agreed upon fee.

11. A method as disclosed in claim 9 further comprising the steps of:
a. checking the customer's membership status;
b. checking the customer's interest in signing up with the system; and
c. obtaining information.

12. A system for selecting desired professionals, comprising:
a. a memory device; and
b. a processor disposed in communication with the memory device, the processor configured to:
i. form a collective of professionals;
ii. enable at least one user sign on to the system;
iii. enable at least one user to provide search criteria;
iv. match the criteria with information on repair persons contained on the system;
v. notify at least one person associated with the information; and
vi. enable at least one user to schedule a project with said at least one person associated with the information.

13. A system as disclosed in claim 12 wherein the processor is further configured to provide a user with a list of repair persons meeting the user's criteria.

14. A system as disclosed in claim 12 wherein the processor is further configured to:
a. enable the coordination of user and repair person schedules; and
b. enable the confirmation of an appointment.

15. A system as disclosed in claim 12 wherein the processor is further configured to:
a. determine whether a match has been made;
b. provide match information;
c. offer the user an alternative recommendation;
d. determine whether the user is satisfied with the alternative recommendation; and
e. refer the user to another source or site.

16. A system as disclosed in claim 12 wherein the processor is further configured to:
a. check the user's membership status;
b. check the user's interest in signing up with the system; and
c. obtain information from the user.

17. A system as disclosed in claim 16 wherein the processor is further configured to receive payment of a fee.

18. A system as disclosed in claim 16 wherein the processor is further configured to:
a. Determine whether the user agrees to a set of terms;
b. Enable users to provide the cost of a project; and
c. Enable users to provide an agreed upon fee.

19. A system as disclosed in claim 17 wherein the processor is further configured to:
a. check the user's membership status;
b. check the user's interest in signing up with the system; and
c. obtain information from the user;

20. A computer readable medium comprising:
a. instruction code for forming a collective of repair persons;
b. instruction code for enabling users to sign on to a system;
c. instruction code for enabling users to provide search criteria;
d. instruction code for matching the criteria with information contained on the system;
e. instruction code for notifying professionals; and
f. instruction code enabling users to schedule a project.

21. A computer readable medium as disclosed in claim 20 further comprising:
a. instruction code for determining whether a match has been made;
b. instruction code for providing match information;
c. instruction code for offering the user an alternative recommendation;
d. instruction code for determining whether the user is satisfied with the alternative recommendation; and
e. instruction code for referring the user to another source.

22. A computer readable medium as disclosed in claim 20 further comprising:
a. instruction code for checking a user's membership status;
b. instruction code for checking the user's interest in subscribing with the system; and
c. instruction code for obtaining information from the user.

23. A computer readable medium as disclosed in claim 22 further comprising:
a. instruction code for enabling the user to pay a requisite fee; and
b. instruction code for receiving the fee.

24. A computer readable medium as disclosed in claim 22 further comprising:
a. instruction code for determining whether the user agrees to a set of terms; and
b. instruction code for enabling a user to provide the cost of a project.

25. A computer readable medium as disclosed in claim 23 further comprising:
a. instruction code for checking the user's membership status;
b. instruction code for checking the user's interest in subscribing to the system; and
c. instruction code for obtaining information from the user.
